(19) United States
(12) Patent Application Publication
(10) Pub. No.: US 2024/0256288 A1
(43) Pub. Date: Aug. 1, 2024

(54) IDENTIFYING AND PROVISIONING BARE METAL SYSTEMS

(71) Applicant: Dell Products L.P., Round Rock, TX (US)

(72) Inventors: XiaoJun WU, Shanghai (CN); Haijun ZHONG, Shanghai (CN); Muzhar S. KHOKHAR, Shrewsbury, MA (US); Feng ZHOU, Shanghai (CN); Kai CHEN, Shanghai (CN)

(73) Assignee: Dell Products L.P., Round Rock, TX (US)

(21) Appl. No.: 18/161,825

(22) Filed: Jan. 30, 2023

(51) Int. Cl. G06F 9/4401; G06F 8/61; G06F 9/455

(52) U.S. Cl. CPC G06F 9/4416; G06F 8/61; G06F 9/45512

(57) ABSTRACT

An information handling system may include at least one processor and a memory. The information handling system may be configured to: receive an indication of a desired role, wherein the desired role has a stack associated therewith; store the desired role in a basic input/output system (BIOS) variable; upon a subsequent boot, transmit the desired role to at least one network destination; and perform a network boot, wherein the network boot is configured to provision the information handling system with the stack based on the desired role.

### TECHNICAL FIELD

The present disclosure relates in general to information handling systems, and more particularly to techniques for provisioning software onto bare-metal information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCl) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCl solution is the Dell EMC VxRail™ system. Some examples of HCl systems may operate in various environments (e.g., an HCl management system such as the VMware® vSphere® ESXi™ environment, or any other HCl management system). Some examples of HCl systems may operate as software-defined storage (SDS) cluster systems (e.g., an SDS cluster system such as the VMware® vSAN™ system, or any other SDS cluster system).

In the HCl context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation of hardware resources such as memory, central processing unit time, disk space, and input and output devices, and provide an interface between such hardware resources and application programs hosted by the guest operating system.

When a new HCl system is to be deployed, it is typically provisioned with a set of components referred to herein as a “stack.” A stack may include an operating system, hypervisor, firmware, drivers, software, etc.

For example, in a cloud-native on-premises deployment, bare metal servers may be used for many different roles, such as nodes associated with different cloud providers, as well as different node types (e.g., Kubernetes control plane nodes, Kubernetes worker nodes, etc.). Bare metal servers may thus be provisioned to different software stacks based on their different intended roles.

Currently, the role of a bare metal server is defined when a user manually provisions the server, which does not lend itself to automation. It would be advantageous to be able to identify the role of a bare metal server in such a way that it may provision itself automatically when booted.

For example, embodiments of this disclosure allow for a bare metal server's role to be defined in non-volatile memory (e.g., in a UEFI BIOS setting). When the server is next booted, it may perform zero-configuration networking setup (zeroconf) and boot from a designated network boot source that may allow it to provision itself with the desired stack.

It should be noted that the discussion of a technique in the Background B section of this disclosure does not constitute an admission of prior-art status. No such admissions are made herein, unless clearly and unambiguously identified as such.

### SUMMARY

In accordance with the teachings of the present disclosure, the disadvantages and problems associated with provisioning of information handling systems may be reduced or eliminated.

In accordance with embodiments of the present disclosure, an information handling system may include at least one processor and a memory. The information handling system may be configured to: receive an indication of a desired role, wherein the desired role has a stack associated therewith; store the desired role in a basic input/output system (BIOS) variable; upon a subsequent boot, transmit desired role to at least one network destination; and perform a network boot, wherein the network boot is configured to provision the information handling system with the stack based on the desired role.

In accordance with these and other embodiments of the present disclosure, a method may include an information handling system receiving an indication of a desired role, wherein the desired role has a stack associated therewith; the information handling system storing the desired role in a basic input/output (BIOS) system variable; upon a subsequent boot, the information handling system transmitting the desired role to at least one network destination; and the information handling system performing a network boot, wherein the network boot is configured to provision the information handling system with the stack based on the desired role.

In accordance with these and other embodiments of the present disclosure, an article of manufacture may include a non-transitory, computer-readable medium having computer-executable instructions thereon that are executable by a processor of an information handling system for: receiving an indication of a desired role, wherein the desired role has a stack associated therewith; storing the desired role in a basic input/output system (BIOS) variable; upon a subsequent boot, transmitting the desired role to at least one network destination; and performing a network boot, wherein the network boot is configured to provision the information handling system with the stack based on the desired role.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example system for performing role identification and provisioning, in accordance with embodiments of the present disclosure.

### DETAILED DESCRIPTION

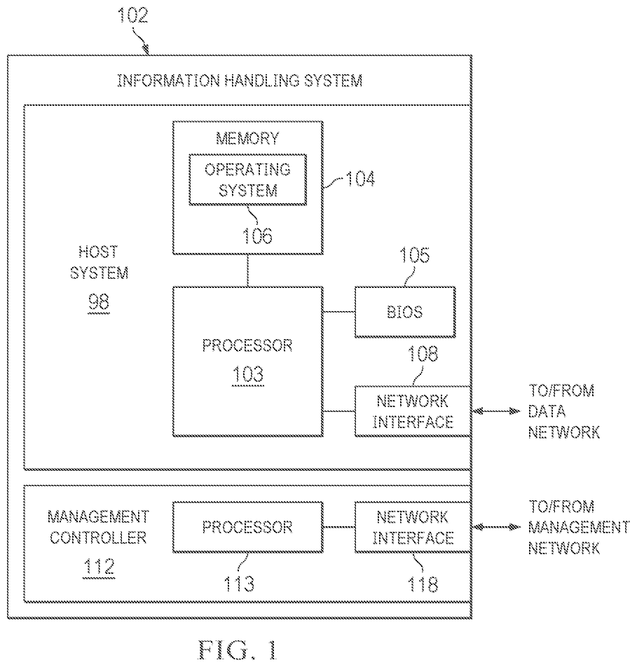

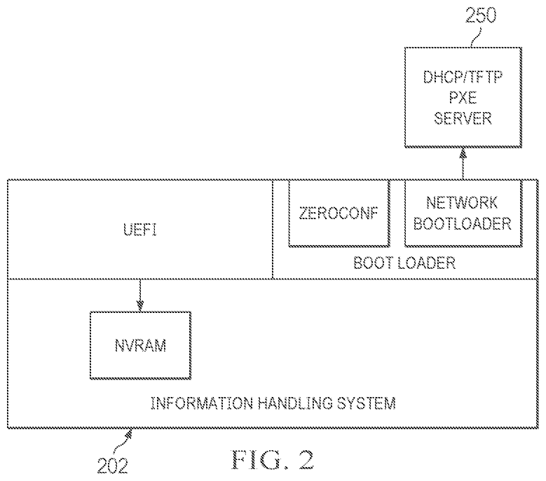

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable may vary device and in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media storing for data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may executable comprise any program of instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate suitable using any transmission protocol and/or standard. In these and other embodiments, network interface 118 may comprise a network interface card, or “NIC.” Network interface 118 may be the same type of device as network interface 108, or in other embodiments it may be a device of a different type.

Information handling system 102 may be a bare metal server in some embodiments. As discussed above, embodiments of this disclosure provide improvements in the provisioning of information handling systems 102 with a desired stack. It should be noted that while the scenario of an information handling cluster such as an HCl system in an on-premises cloud-native deployment is discussed in detail herein for the sake of concreteness, other embodiments are also specifically contemplated within scope the of this disclosure.

In one embodiment, a role for information handling system 102 may be defined in a variable stored in BIOS 105 or a non-volatile random-access memory (NVRAM) accessible by BIOS 105. This role may be set in a factory environment prior to delivery of information handling system 102 in one embodiment. In another embodiment, subsequent to delivery, a user of information handling system 102 may boot it to a command shell (e.g., a UEFI shell) and execute one or more commands to set the role variable.

During a UEFI boot after the role has been set, an EFI boot loader referred to as a cloud-native boot loader which includes zeroconf functionality may be initialized. The boot loader may first read the system's role from NVRAM, and it may then publish and identify the role to the on-premises network using the zeroconf networking functionality. Based on the role identified, the boot loader may then provision information handling system 102 via a network boot such as a Preboot Execution Environment (PXE) boot. Thus a user can order a bare metal server, and once it arrives at the premises, it may be automatically provisioned for its role by a cloud-native bootloader.

Turning now to FIG. 2, a system is shown for provisioning information handling system 202 via a PXE server 250. In this example, information handling system 202 is to be provisioned as an EKS-D control plane node. As one of ordinary skill in the art will appreciate, Amazon EKS Distro (EKS-D) is a Kubernetes distribution based on Amazon Elastic Kubernetes Service (EKS) that may be used to create Kubernetes clusters.

In this example, information handling system 202 arrives at the on-premises location with no role predefined. A role may then be set by a user via a UEFI shell command. For example, a UEFI shell command for identifying the role in this example might be as follows:
set server_role aws_eksd_admin_control_plane

When information handling system 202 is first booted, the boot loader with zeroconf networking may read the role from NVRAM, and then publish and identify the role to the on-premises subnetwork. After the role is identified, the network bootloader may connect to PXE server 250 to allow it to be provisioned with the desired stack. Based on the defined role that has been broadcast to the subnetwork, PXE server 250 may then transmit all of the needed stack components to information handling system 202 for installation. For example, PXE server 250 may cause information handling system 202 to boot to a small provisioning operating system, which may then download and install the correct software stack to the storage resources of information handling system 202. When information handling system 202 next reboots, it may initialize the desired stack.

Accordingly, information handling system 202 may be provisioned to any desired stack based on its defined role additional manual configuration during the without provisioning phase.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112 (f) for that claim element. Accordingly, none of the claims in this application as filed are intended to be interpreted as having means-plus-function elements. Should Applicant wish to invoke § 112 (f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
receive an indication of a desired role, wherein the desired role has a stack associated therewith;
store the desired role in a basic input/output system (BIOS) variable;
upon a subsequent boot, transmit the desired role to at least one network destination; and
perform a network boot, wherein the network boot is configured to provision the information handling system with the stack based on the desired role.

2. The information handling system of claim 1, wherein the information handling system is a hyper-converged infrastructure (HCl) system.

3. The information handling system of claim 1, wherein the indication of the desired role is received during a manufacturing process of the information handling system.

4. The information handling system of claim 1, wherein the indication of the desired role is received via a UEFI shell.

5. The information handling system of claim 1, wherein performing the network boot comprises retrieving a provisioning operating system from a Preboot Execution Environment (PXE) server.

6. The information handling system of claim 5, wherein the provisioning operating system is configured to download and install components of the stack.

7. A method comprising:
an information handling system receiving an indication of a desired role, wherein the desired role has a stack associated therewith;
the information handling system storing the desired role in a basic input/output system (BIOS) variable;
upon a subsequent boot, the information handling system transmitting the desired role to at least one network destination; and
the information handling system performing a network boot, wherein the network boot is configured to provision the information handling system with the stack based on the desired role.

8. The method of claim 7, wherein the information handling system is a hyper-converged infrastructure (HCl) system.

9. The method of claim 7, wherein the indication of the desired role is received during a manufacturing process of the information handling system.

10. The method of claim 7, wherein the indication of the desired role is received via a UEFI shell.

11. The method of claim 7, wherein performing the network boot comprises retrieving a provisioning operating system from a Preboot Execution Environment (PXE) server.

12. The method of claim 11, wherein the provisioning operating system is configured to download and install components of the stack.

13. An article of manufacture comprising a non-transitory, computer-readable medium having computer-executable instructions thereon that are executable by a processor of an information handling system for:
receiving an indication of a desired role, wherein the desired role has a stack associated therewith;
storing the desired role in a basic input/output system (BIOS) variable;
upon a subsequent boot, transmitting the desired role to at least one network destination; and
performing a network boot, wherein the network boot is configured to provision the information handling system with the stack based on the desired role.

14. The article of claim 13, wherein the information handling system is a hyper-converged infrastructure (HCl) system.

15. The article of claim 13, wherein the indication of the desired role is received during a manufacturing process of the information handling system.

16. The article of claim 13, wherein the indication of the desired role is received via a UEFI shell.

17. The article of claim 13, wherein performing the network boot comprises retrieving a provisioning operating system from a Preboot Execution Environment (PXE) server.

18. The article of claim 17, wherein the provisioning operating system is configured to download and install components of the stack.
